(19) United States
(12) Patent Application Publication
(10) Pub. No.: US 2008/0190788 A1
(43) Pub. Date: Aug. 14, 2008

(54) Container

(75) Inventor: David A. Cziraky, Bethlehem, PA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Crayola LLC, Easton, PA (US)

(21) Appl. No.: 11/704,400

(22) Filed: Feb. 9, 2007

(51) Int. Cl. A45C 11/34; B43L 23/00

(52) U.S. Cl. 206/214; 30/451

(57) ABSTRACT

The container stores and dispenses writing instruments. The container has a modular capability such that sets of writing instruments may be easily removed and distributed separate from the container. In this way, the writing instruments may be quickly dispersed to groups of individuals. The modular capability is achieved through the use of components, such as bins, for storing the writing instruments that are removably stored within the container. For example, a sharpener is also provided for sharpening writing instruments. The sharpener may be removably disposable within a bin and may have a truncated generally pyramidal shape. The sharpener may comprise a plurality of apertures for receiving writing instruments for sharpening. The sharpener may be disposed within the container similar to the writing instrument bins.

### BACKGROUND

Containers for storing and distributing writing instruments, such as crayons and markers, are used in classroom settings. They provide for the storage of a sufficiently large number of writing instruments for utilization by a group of individuals such as a classroom of students.

Current containers have fixed compartments for storing writing instruments. They operate as a distribution center for distributing the writing instruments to the group of individuals. Each fixed compartment stores a respective color of writing instrument in a horizontal orientation. Thus, in order to distribute a set of colored writing instruments to a group of individuals, the set must be created at the time of distribution by taking a writing instrument from each compartment. Each individual or individuals receiving a set must wait for their set to be put together and wait for their turn to receive their set from the container. This can be time consuming inasmuch as the set building and distribution takes place one at a time from the container, thus forming a bottleneck in the distribution process.

Current containers are thus extremely inefficient resulting in lost time and wasted energy, which is particularly problematic in a classroom environment where learning time should be at a premium and unnecessary distractions detract from the learning environment. Therefore, there is a need for an improved storage and distribution container for use with school or office supplies such as writing instruments.

### BRIEF SUMMARY

A container for storing and dispensing writing instruments. The container has a modular capability such that sets of writing instruments may be easily removed and distributed separate from the container. In this way, the writing instruments may be quickly dispersed to groups of individuals. The modular capability is achieved through the use of components, such as bins, for storing the writing instruments that are removably stored within the container. Once finished with the writing instruments, each individual or group of individuals may then return the instruments to their respective bins for collection and subsequent return to the container. In this way, the writing instruments are ready to be efficiently redistributed at a later time. The container may also be used to store and distribute other school supplies and/or accessories.

A sharpener is also provided for sharpening writing instruments. The sharpener may be removably disposable within a bin and may have a truncated generally pyramidal shape. The sharpener may comprise a plurality of apertures for receiving writing instruments for sharpening. The sharpener may be removably disposed within the container similar to the writing instrument bins.

### BRIEF DESCRIPTION OF THE DRAWINGS

FIG. 1 is a perspective view of an embodiment of a modular writing instrument storage and distribution container;

FIG. 2 is an exploded perspective view of the modular writing instrument storage and distribution container of FIG. 1;

FIG. 3 is a perspective view of a bin containing sleeves and crayons;

FIG. 4 is a perspective view of the bin of FIG. 3 containing only crayons;

FIG. 5 is a perspective view of an embodiment of a sharpener;

FIG. 6 is a top plan view of the sharpener of FIG. 5;

FIG. 7 is an elevational side view of the sharpener of FIG. 5;

FIG. 8 is a cross-sectional view taken through line 8-8 of FIG. 6 of the sharpener of FIG. 5;

FIG. 9 is a perspective view of another embodiment of a modular writing instrument storage and distribution container;

FIG. 10 is a perspective view of a bin containing markers;

FIG. 11 is a perspective view of another embodiment of a modular writing instrument storage and distribution container;

FIG. 12 is a perspective view of a bin containing pencils; and

FIG. 13 is a perspective view of another embodiment of a modular writing instrument storage and distribution container.

### DESCRIPTION

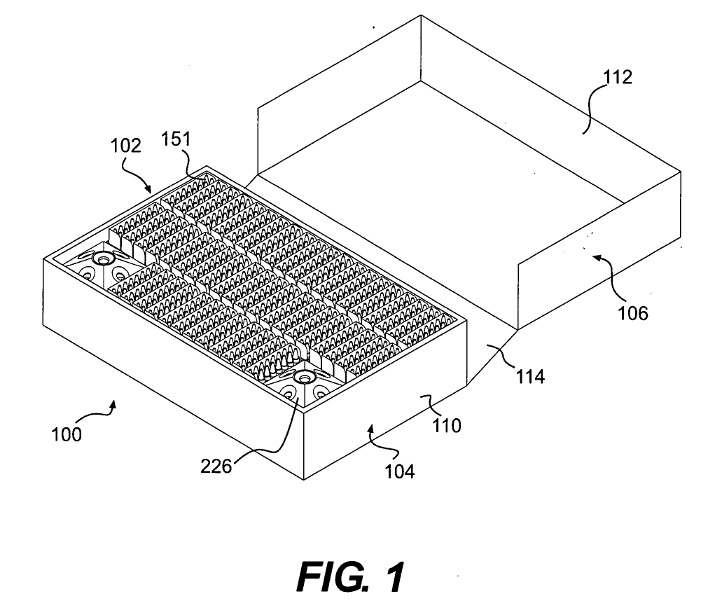

Turning to the figures, wherein like shown elements may represent like structures, FIG. 1 shows a container 100 for storing and distributing school or office supplies such as writing instruments and accessories. As shown, the container 100 may comprise a plurality of writing instruments 102, such as crayons 151. The writing instruments 102 may be disposed within a base section 104 of the container 100. The container 100 may further comprise a lid 106 to cover the writing instruments 102 and retain the instruments 102 within the container 100 when not in use. Thus, the container 100 provides a centralized structure for storing a large quantity of writing instruments 102 in a single stackable and convenient structure, while enabling the distribution of large quantities of writing instruments 102 to groups of individuals with minimal effort.

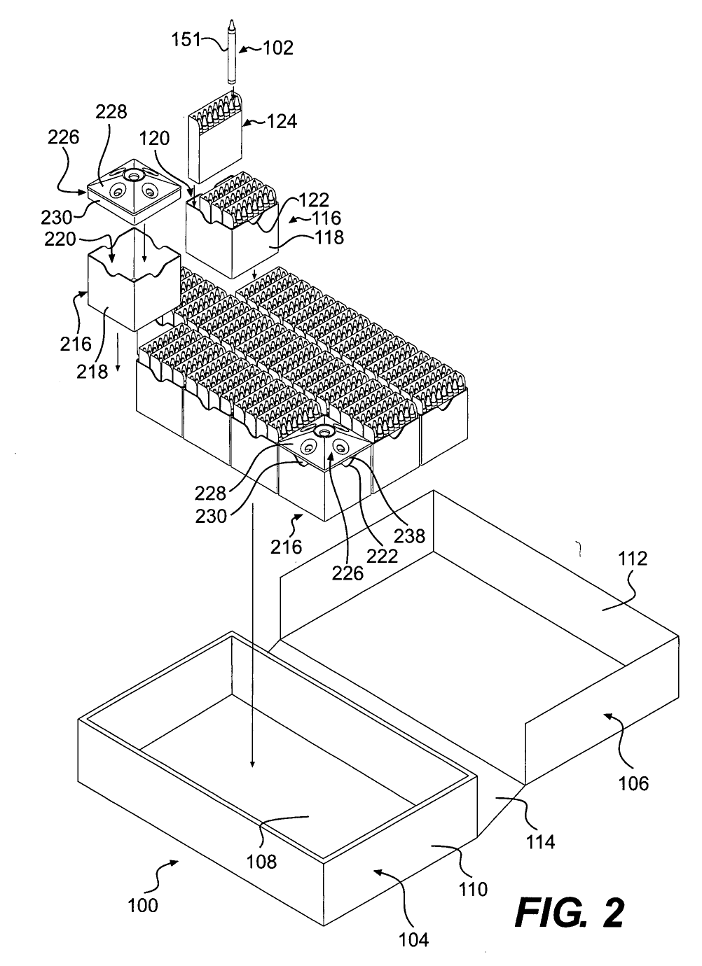

As shown in FIG. 2, the base 104 of the container 100 may comprise a bottom surface 108 and a plurality of sidewalls 110 projecting vertically from the bottom surface 108. Similarly, the lid 106 may comprise a plurality of flaps 112 that fit externally adjacent to the sidewalls 110 when the lid 106 is folded over the base 104 to close the container 100. As shown, the lid 106 may be hingedly coupled to the base 104 via a hinge portion 114, while in other embodiments, the lid 106 may be a separate structure from the base 104 that fits over the top of the base 104. It will be appreciated that the container 100 may be any suitable shape and size. It will further be appreciated that the lid 106 may have any suitable shape and size, and the lid 106 may enclose the contents of the container 100 in any suitable manner.

A plurality of modular bins 116 may be disposed within the container 100. The bins 116 fit within the base 104 of the container 100 and may be easily inserted and removed from the container 100. The bins 116 may be generally box-like in shape. For example, the bins 116 may have a base for supporting writing instruments 102, a sidewall 118 extending vertically from each side of the base, and the bins 116 may have an open top 120 for the insertion of objects into the bin 116. The bins 116 may further have one or more notches 122 disposed near the top of the sidewall 118. The notches 122 permit access for an individual to grip and remove items disposed in the bin 116, as will be further explained below.

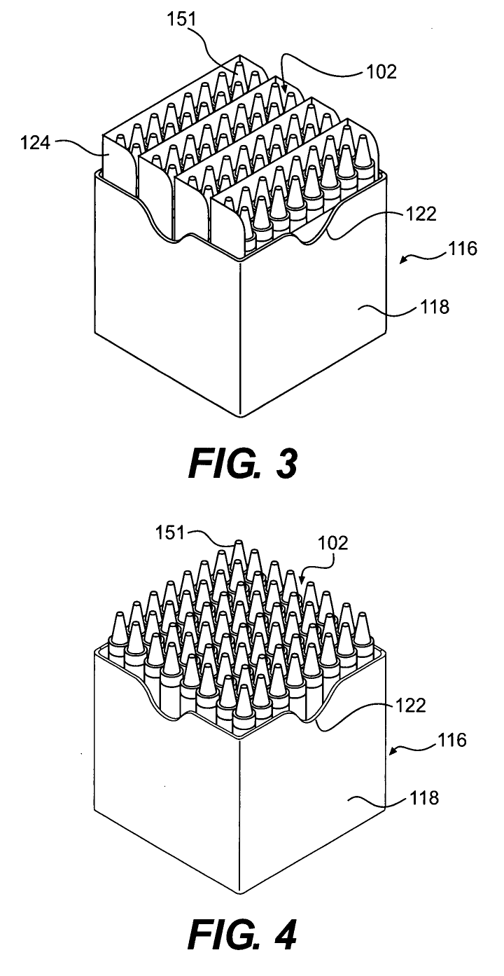

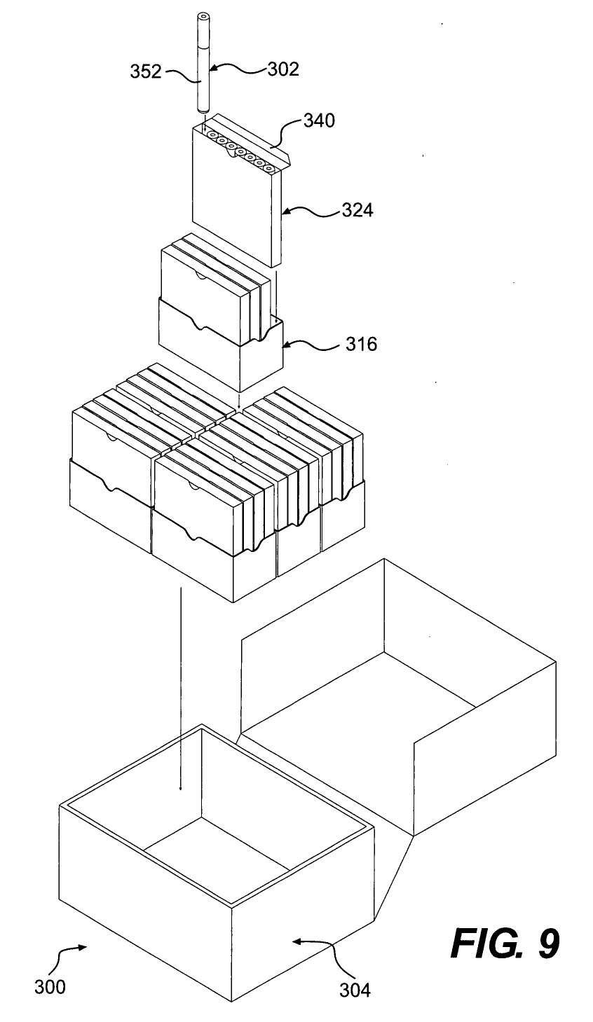

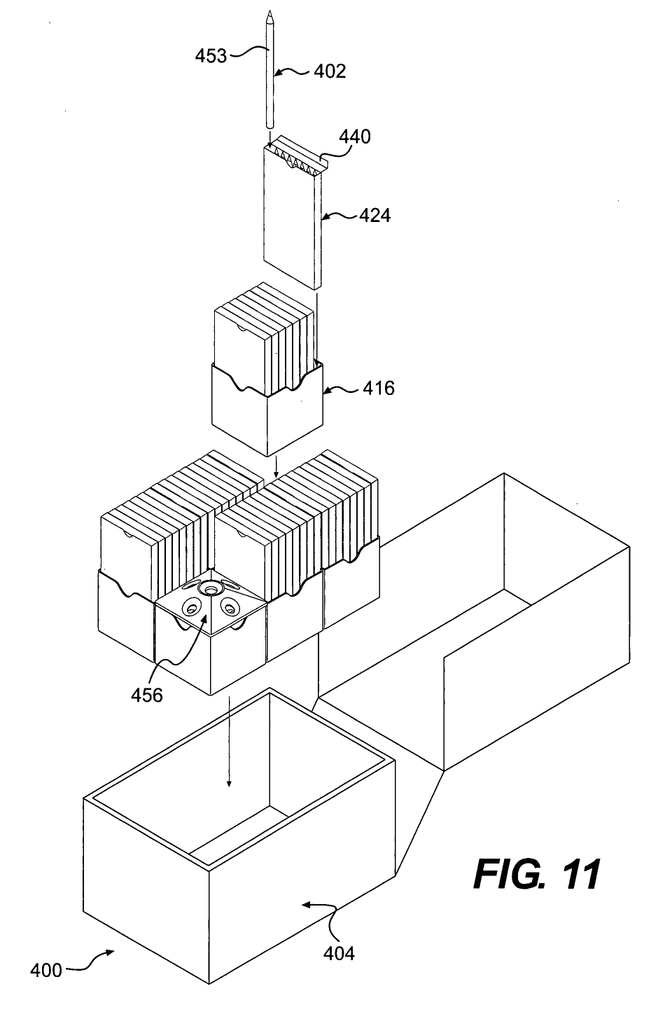

In some embodiments, the bin 116 may contain one or more sleeves 124 that may be removably disposed in the bin 116. As shown in FIG. 3, the sleeves 124 may hold one or more rows of writing instruments 102. In some embodiments, each sleeve 124 may contain a complete set of crayon colors. For example, the bin 116 shown in FIG. 3 may contain four sleeves 124 wherein each sleeve 124 comprises sixteen crayons 151 of different colors. Thus, four complete sets of crayons 151 are contained in the bin 116. In some embodiments, the sleeves 124 may be provided for initial packaging and distribution of the containers 100, but may be intended for disposal before or after use of the writing instruments 102. In other embodiments, the sleeves 124 may not be provided at all. For example, FIG. 4 shows a bin 116 containing crayons 151 without sleeves 124, such as when the container 100 is provided without sleeves or after removal and disposal of the sleeves 124. In some embodiments, each sleeve 124 may have a lid (such as the lids shown in FIGS. 9 and 11) for enclosing the sleeve 124. In further embodiments, the sleeves 124 may be fixed within the bins 116 to operate as dividers within the bins 116.

Referring again to FIGS. 3 and 4, the writing instruments 102 are stored vertically within the bins 116. This vertical arrangement permits the return of the writing instruments 102 to the bin 116 to be accomplished in an efficient and orderly manner. For example, a handful of writing instruments 102 may be picked up and inserted vertically into the bin 116. If one or more of the instruments 102 become askew, they are easily accessible and may be correctly arranged with minimal effort. The vertical orientation also permits all of the writing instrument colors to be visible and easily accessible because each instrument 102 holds a conspicuous position within the bin 116. Thus, an individual need not search through a stack of instruments 102 to locate a particular color. Finally, storing the writing instruments 102 vertically may help to reduce the amount of horizontal shelf space taken up by the container 100. It will be appreciated, however, that the writing instruments 102 may be disposed in any suitable orientation, including but not limited to, vertically and horizontally.

In addition to or in place of the writing instruments, the container may contain one or more accessories. For example, some writing instruments, such as crayons and pencils, require a sharpener to sharpen the writing instrument when the tip has dulled during use. Thus, as shown in FIGS. 1 and 2, a sharpener 226 may be provided within the container 100. Similar to the bins 116 described above for containing writing instruments 102, the sharpener 226 may have modular characteristics. Therefore, the sharpener 226 may be removed from the container and distributed to individuals or groups of individuals to permit sharpening of writing instruments 102 independent from the container 100.

In some embodiments, such as shown in FIGS. 1 and 2, the sharpener 226 has a structure suitable for fitting within a bin 216 similar or identical to the bins 116 used to house the writing instruments 102. For example, the sharpener 226 may fit above and within the bin 216, and the sharpener 226 may be removable from the bin 216. The bin 216 receives instrument shavings that are created as a writing instrument 102 is sharpened. The shavings drop from below the sharpener and fall into the open top 220 of the bin 216 for storage in the area formed by the bin base and sidewalls 218. When the bin 216 is full, the sharpener 226 may be lifted out of the bin 216, and the shavings may be removed from the bin 216 for disposal.

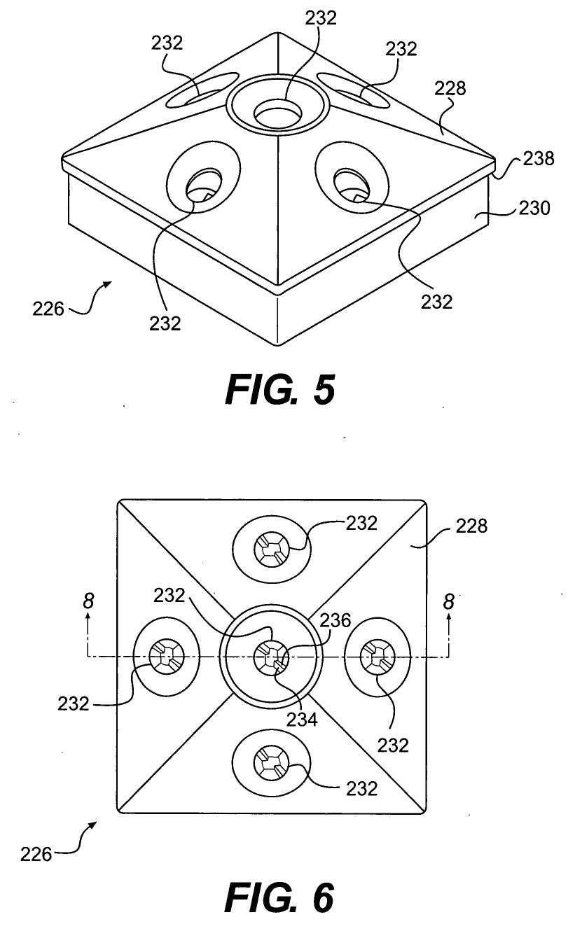

As shown in FIG. 5, the sharpener 226 may comprise an upper portion 228 and a lower portion 230. As can be seen in FIGS. 5 and 6, the upper portion 228 may comprise one or more writing instrument receiving apertures 232. The writing instrument receiving apertures 232 have a diameter sufficient to permit a desired type of writing instrument 102 to be inserted into the aperture 232 for sharpening. As shown, the upper portion 228 is generally pyramidal in shape with five receiving apertures 232. Four of the receiving apertures 232 are disposed on respective sides of the pyramidal shape while the fifth receiving aperture 232 is disposed at the peak of the upper portion 228, which may be truncated. It will be appreciated that the sharpener 226 may be any suitable shape and may have any suitable number of receiving apertures 232.

As shown in FIGS. 6 and 8, one or more sharpener blades 234 are disposed within each receiving aperture 232. The blades 234 are disposed at an angle relative to the direction of entry of a writing instrument 102. As the instrument 102 is rotated, the blades 234 shave portions of the instrument 102 off to form a relatively pointed tip. Slits 236 are disposed such that as the shavings are removed from the instrument 102, they slide behind the blade 234 and into the slits 236. From the slits 236, the shavings drop into the bin 216.

Having multiple apertures 232 for receiving and sharpening writing instruments 102 permits more than a single individual to sharpen an instrument 102 at the same time. Furthermore, providing multiple sharpeners 226 and multiple apertures 232 distributes the wear and tear of sharpening amongst multiple blades 234. Blades 234 may dull from normal usage over time making them less effective. Having more blades 234 lengthens the effective life of the sharpeners 226 and is particularly beneficial for containers 100 that contain a large number of writing instruments 102 or containers 100 with writing instruments 102 that are used frequently.

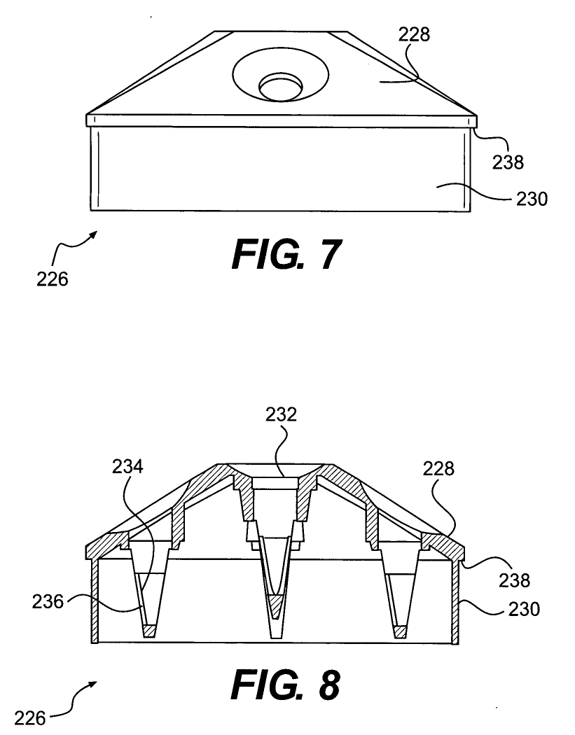

Referring to FIG. 7, the lower portion 230 of the sharpener 226 extends downward from the upper portion 228, and is recessed inward relative to the upper portion 228. This forms a ledge 238 near the intersection of the upper portion 228 and the lower portion 230. When the sharpener 226 is disposed within a bin 216, such as shown in FIG. 2, the lower portion 230 fits within the bin 216 to secure the sharpener laterally within the bin 216. The ledge 238 rests on the top of the bin 216. The notches 222 in the bin 216 permit a user to easily remove the sharpener 226 from the bin 216 by providing access to the ledge 238. A user may grip the ledge 238 at the notch 222 and lift the sharpener 226 out of the bin 216.

In the illustrated embodiment shown in FIGS. 1 and 2, each sleeve 124 may contain two rows with eight crayons 151 in each row. Each bin 116 may comprise four sleeves 124, and the container 100 may comprise three rows of five bins 116 in each row. Thirteen of the bins 116 may comprise crayons 151, while the remaining two bins 216 may comprise crayon sharpeners 226. It will be appreciated that the container 100 may be any suitable size for containing any suitable number of bins 116/216. Further, the bins 116 may be any suitable size to contain any suitable number of crayons 151 or any suitable number of crayons 151 disposed within any suitable number of sleeves 124. Additionally, any suitable number of the bins 216 may be utilized as sharpeners 226.

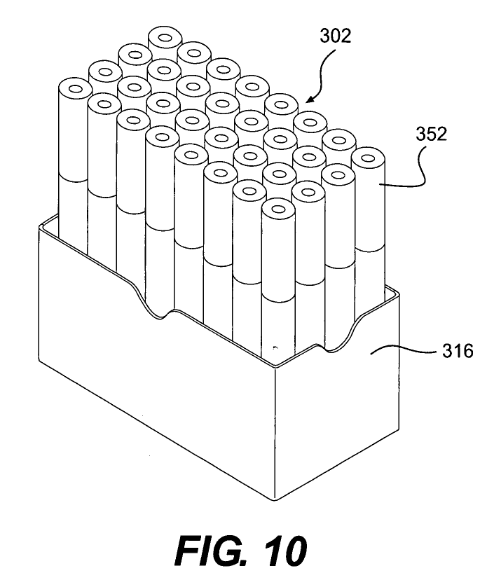

Turning to FIG. 9, another embodiment of a container 300 for storing and distributing writing instruments 302 is shown. As described above, the container 300 may have a base 304 for receiving one or more bins 316. In this embodiment, the bins 316 are used to contain markers 352. In some embodiments, the container 300 may be provided without sleeves 324 such that the markers 352 may be disposed directly in the bins 316 (such as shown in FIG. 10) while in other embodiments, the markers 352 may be disposed within sleeves 324 that fit within the bins 316. The sleeves 324 may have flaps 340 that fold over the tops of the sleeves 324 to enclose the markers 352 disposed therein. As described above, the sleeves 324 may be provided for ease of initial packaging of the markers 352 into the bins 316. If desired, the consumer may discard the sleeves 324 and reinsert the markers 352 directly into the bins 316, such as shown in FIG. 10, for storage and distribution.

As shown in the illustrated embodiment of FIGS. 9 and 10, the bins 316 are rectangular to accommodate four sleeves 324 with eight markers 352 to a sleeve 324 or four rows of eight markers 352. The container 300 in this embodiment has three rows with two bins 316 in each row. As described above, the writing instruments 302 may be disposed vertically to provide easy accessibility, organization, distribution, and clean-up. In other embodiments, the writing instruments 302 may be disposed horizontally or another suitable orientation.

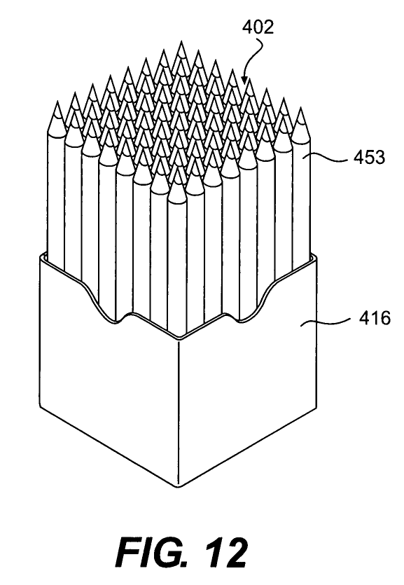

Another embodiment of a container 400 similar to the embodiments described above is shown in FIG. 11 for storing and distributing writing instruments 402. In this embodiment, the writing instruments 402 are colored pencils 453. The container 400 may comprise a base 404 for receiving one or more bins 416 suitable for containing colored pencils 453. In some embodiments, the container 400 may be provided without sleeves 424 such that the colored pencils 453 may be disposed directly in the bins 416 (such as shown in FIG. 12) while in other embodiments, the colored pencils 453 may be disposed within sleeves 424 that fit within the bins 416. The sleeves 424 may have flaps 440 that fold over the tops of the sleeves 424 to enclose the colored pencils 453 disposed therein. As described above, the sleeves 424 may be provided for ease of initial packaging of the colored pencils 453 into the bins 416. If desired, the consumer may discard the sleeves 424 and reinsert the colored pencils 453 directly into the bins 416, such as shown in FIG. 12, for storage and distribution.

It will be appreciated that a sharpener 456 for sharpening colored pencils may be provided with a container (such as container 400) for storing and distributing colored pencils. The sharpener 456 may be removably disposed within the container. The sharpener 456 may be any suitable size and shape and may contain any suitable number of receiving apertures and blades. As in embodiments described above, the sharpener 456 may comprise an upper portion and a lower portion. The upper portion may be pyramidal in shape, and the lower portion may fit within a bin.

As shown in the illustrated embodiment of FIGS. 11 and 12, the bins 416 are generally cube-like in shape to accommodate eight sleeves 424 with eight colored pencils 402 to a sleeve 424 or eight rows of eight colored pencils 402. The container 400 in this embodiment has three rows with two bins 416 in each row. As described above, the writing instruments 402 may be disposed vertically to provide easy accessibility, organization, distribution, and clean-up. In other embodiments, the writing instruments 402 may be disposed horizontally or another suitable orientation.

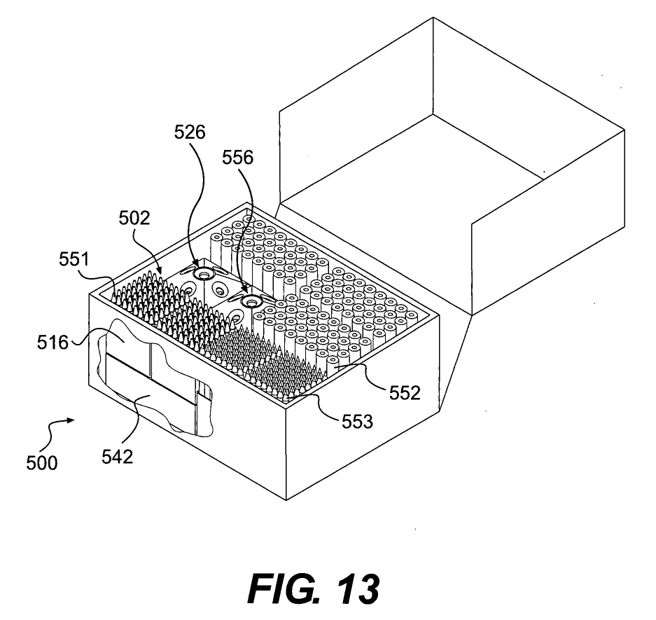

It will be appreciated that more than one type of school or office supply such as more than one type of writing instrument may be provided in a container. By way of example and not limitation, turning to FIG. 13, the container 500 may comprise one or more suitable types of writing instruments 502 such as crayons 551, markers 552, and colored pencils 553 for distribution of multiple types of writing instruments 502 to a group of individuals. As shown, the container 500 may comprise two bins of crayons 551, three bins of markers 552, two bins of colored pencils 553, a crayon sharpener 526, and a colored pencil sharpener 556. The crayon bins may comprise eight rows of eight crayons 551, the marker bins may comprise four rows of eight markers 552, and the colored pencil bins may comprise eight rows of eight colored pencils 553.

Considering that some writing instruments 502 are smaller than others, a structure may be provided to ensure that all of the writing instruments 502 are easily accessible and presented at approximately the same level relative to one another. For example, crayons 551 are often smaller in length than markers 552 and colored pencils 553. Thus, as shown in FIG. 13, in order to compensate for this length differential, one or more steps 542 may be provided. As shown, the step 542 is disposed below the bins 516 used to store the crayons 551. The step 542 has a height sufficient to compensate for the difference in length between the crayons 551 and the markers 552 and colored pencils 553. The step 542 may be fixed within the container 500 or may be removably disposed within the container 500. It will be appreciated that the step 542 may be any suitable size and shape to compensate for a difference in length between writing instruments 502 stored within a container 500. A step 542 similar to the step shown in FIG. 13 may also be used to support a sharpener or other suitable accessory. Any suitable number of steps 542 may be provided. In other embodiments, the sharpeners 526, 556 may be disposed within a bin having a larger height such that the top of the sharpener is relatively level with the writing instruments. Such a bin would also be able to contain more crayon or pencil shavings before emptying.

Examples of suitable school or office supplies such as writing instruments, art supplies, and accessories that may be disposed in a container and distributed in a modular manner include but are not limited to, crayons, markers, colored pencils, chalk, pens, glue sticks, paints, and modeling compounds. It will be appreciated, however, that any suitable type of supply may be stored and distributed from the container in a modular manner and may be provided in any suitable combination of types or colors.

As described above, it will be appreciated that the container may be any suitable size for containing any suitable number of bins. The bins may be arranged in any suitable number of rows and columns. Further, the bins may be any suitable size to contain any suitable number of school or office supplies such as writing instruments, art supplies, accessories, and/or any combination thereof. Additionally, the bins may be any suitable size to contain any suitable number of supplies disposed within any suitable number of sleeves. The sleeves may be of any suitable size to hold the supplies in any suitable arrangement.

It will be appreciated that the container, bins, and sleeves may be constructed of cardboard, paperboard, metal, plastic, or any other suitable material. The plastic may be an injection molded plastic such as polypropylenes, styrenes, or other suitable plastics. The plastic may also be ethylene vinyl acetate (EVA) foam, which may be die cut and assembled or formed such as by thermal forming.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor(s) for carrying out the invention. Variations of those preferred embodiments may become apparent to those of ordinary skill in the art upon reading the foregoing description. The inventor(s) expect skilled artisans to employ such variations as appropriate, and the inventor(s) intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A container for storing and dispensing writing instruments, the container comprising:
a base portion;
a plurality of bins removably disposed within the base portion, at least one of the plurality of bins having a plurality of writing instruments disposed therein; and
whereby the plurality of writing instruments are oriented substantially vertically when disposed within the at least one of the plurality of bins.

2. The container of claim 1 wherein the writing instruments are selected from the group consisting of crayons, markers, and colored pencils.

3. The container of claim 1 further comprising a sharpener for sharpening the writing instruments.

4. The container of claim 3 wherein the sharpener is removably coupled to a bin.

5. The container of claim 3 wherein the sharpener has a plurality of apertures with blades disposed therein for sharpening writing instruments.

6. The container of claim 1 wherein a plurality of types of writing instruments are disposed within the container.

7. The container of claim 1 further comprising a step for supporting at least one of the plurality of bins.

8. The container of claim 1 further comprising a sleeve for containing writing instruments disposed within at least one of the plurality of bins.

9. The container of claim 8 wherein the sleeve includes a lid.

10. The container of claim 8 wherein the sleeve is disposable.

11. The container of claim 1 wherein at least one of the plurality of bins comprises a notch.

12. The container of claim 1 wherein the container comprises a lid.

13. The container of claim 1 wherein the plurality of bins have open tops.

14. The container of claim 1 wherein the container comprises a plurality of rows of bins.

15. The container of claim 1 wherein the container comprises a plurality of columns of bins.

16. A container for storing and dispensing writing instruments, the container comprising:
a base portion;
a plurality of bins removably disposed within the base portion, at least one of the plurality of bins including a plurality of writing instruments; and
a sharpener for sharpening the writing instruments, the sharpener being removably disposed within the base portion.

17. The container of claim 16 wherein the writing instruments are selected from the group consisting of crayons, markers, and colored pencils.

18. The container of claim 16 wherein the sharpener is removably coupled to a bin.

19. The container of claim 16 wherein the sharpener has a plurality of apertures with blades disposed therein for sharpening writing instruments.

20. The container of claim 16 wherein a plurality of types of writing instruments are disposed within the container.

21. The container of claim 16 further comprising a sleeve for containing writing instruments disposed within at least one of the plurality of bins.

22. A method of distributing school supplies to a plurality of groups of students, the method comprising:
providing a container having a plurality of removable bins, at least two of the plurality of removable bins containing identical sets of school supplies;
removing a first bin containing school supplies from the container;
giving the first bin to a first group of students such that the first group can use the school supplies;
removing a second bin containing school supplies from the container;
giving the second bin to a second group of students such that the second group can use the school supplies; and
returning the first and second bins to the container for storage.

23. A sharpener for sharpening writing instruments, the sharpener comprising:
a generally pyramidal structure having an upper surface;
a plurality of apertures disposed in the upper surface; and
a blade disposed below each of the plurality of apertures for sharpening the writing instruments.
